(19) United States
(12) Patent Application Publication
(10) Pub. No.: US 2002/0161056 A1
(43) Pub. Date: Oct. 31, 2002

(54) Aerosol adhesive and canister-based aerosol adhesive system

(75) Inventor: David W. Carnahan, Bremerton, WA (US)

Correspondence Address: HINKLE & O'BRADOVICH, LLC, 395 SCENIC HIGHWAY, LAWERENCEVILLE, GA, 30045, US

(73) Assignee: Westech Aerosol Corporation, Port Orchard, WA

(21) Appl. No.: 10/132,620

(22) Filed: Apr. 25, 2002

Related U.S. Application Data
(60) Provisional application No. 60/287,671, filed on Apr. 30, 2001.

(51) Int. Cl. B01F 3/04

(52) U.S. Cl. 516/1

(57) ABSTRACT

In general, a cannister-based low and non-VOC aerosol adhesive is disclosed. The aerosol adhesive typically includes a high solids polymeric base, a hexane acetone solvent mixture and a compressed gas dissolved within the solvent. The compressed gas typically includes carbon dioxide, nitrogen, nitrous oxide and air. The aerosol adhesive is adapted to be filled into a cannister including a hose connected to the canister and a spray gun connected to the hose.

Priority based on U.S. Provisional Patent Application No. 60/287,671, filed Apr. 30, 2001, and entitled “Cannister-Based Aerosol Adhesive” is claimed.

### BACKGROUND OF THE INVENTION

I. Field of the Invention

The present invention relates generally to the field of aerosols and aerosol adhesives and more particularly to canister-based aerosol adhesives.

II. Description of the Related Art

Aerosols have a variety of uses in modern society. Consumers typically use aerosols in convenient size aerosol dispensers. There are also industrial applications that use larger aerosol dispensers, on the order of five gallons, that use hose and gun configurations to dispense the aerosols. In particular, aerosol adhesives are used in large dispensers in order to apply adhesive to bond various surfaces. Adhesives can come in various forms such as natural, organic, vegetable and synthetic. There are several classes of polymeric based synthetic adhesives such as thermosetting adhesives, thermoplastic resins and elastomeric adhesives to name a few. Typically aerosols and aerosol adhesives emit volatile organic compounds (VOCs) during their use.

In many localities, VOCs are regulated. VOC regulations govern both the solvent which the polymer is dissolved and the propellant. Most organic solvents are VOCs. Since aerosol adhesives emit VOCs in their use, aerosol adhesives can fall within these regulations. Regulations can differ depending on the locality, the compounds used and the size of the dispensing container. The compounds typically of concern are the propellants that are primarily contain hydrocarbons and dimethyl ether. The hydrocarbons typically include propane, butane and isobutane, which are all typically flammable. These propellant gases are widely used in aerosols. These hydrocarbons also typically act as a solvent when compressed because they become liquids. They are referred to as liquified gases. Other propellants, which are also liquified gases include chlorofluorocarbons (CFCs), hydrofluorocarbons (HFCs) and hydrochlorofluorocarbons (HCFCs). A variety of other compressible gases such as carbon dioxide, nitrous oxide, nitrogen and air may be used as propellants. These gases are referred to as compressible gases because at normal working pressures for aerosol formulators they do not form liquids.

As mentioned, the regulations can differ. For example, in California, there are two levels for regulating VOC emissions. One level is the State of California, and the other is the local air districts. Many of the local air districts do not classify aerosol containers as aerosol if they weigh more than one pound, rather, they classify them as bulk or liquid contact adhesives. The VOC regulations for bulk or liquid contact adhesives are typically much more stringent than the VOC regulations for aerosols. Therefore, many manufacturers have gone to manufacturing water based products because they can not manufacture compliant adhesive formulation.

Finally, a typical formula for aerosol adhesives is 28 lb. of adhesive (30 percent solids—12 percent SIS rubber and 18 percent resin) 12 lb. of hydrocarbon propellant (50 percent propane and 50 percent isobutane).

The solvent system typically used to dissolve the rubber and resin is methylene chloride or bromo-propane. In this formulation, Typically, the adhesive concentrate is prepared by the 28 lbs of the rubber resin mixture being dissolved in a solvent, which is then pumped into a large aerosol cylinder. After the adhesive concentrate is added, the formulation is then pumped into the cylinder. In addition, 12 pounds of propellant (a blend of propane and isobutane) is typically added. This adhesive has the desired characteristics but, however, it is high in VOC due to the propellent. Furthermore, it has toxicity problems due to the large amount of chlorinated solvent also typically included. Typically, in aerosol adhesives the solvent chosen form dissolving the adhesive is a chlorinated solvent. The solvent must dissolve all of the components of the adhesive. One necessary ability of the solvent is the ability to dissolve the polymer and the resin. Another necessary property of the solvent is that it should evaporate quickly. These properties allow the end user to adhere the surfaces as quickly as possible. Typically, the chlorinated solvents are methylene chloride and bromo-propane. Although these compounds can be used, there are certain health hazards associated with them.

### SUMMARY OF THE INVENTION

In accordance with the present invention and the contemplated problems which have and continue to exist in this field, the invention features an aerosol adhesive and canister based aerosol adhesive system having low VOC emissions and having a spray pattern and low viscosity suitable for aerosol adhesive applications.

In general, in one aspect, the invention features an aerosol adhesive, including a solvent mixture, a polymeric base in the solvent mixture; and a compressed gas dissolved in the solvent mixture.

In one implementation, the polymeric base includes styrene block polymers.

In another implementation, the polymeric base includes styrene butadiene polymers.

In another implementation, the polymeric base includes neoprene.

In another implementation, the solvent mixture comprises a blend of hexane and acetone.

In another implementation, the compressed gas is carbon dioxide.

In still another implementation, the compressed gas is nitrous oxide.

In yet another implementation, the compressed gas is nitrogen.

In another implementation, the compressed gas is air.

In another implementation, the aerosol adhesive further includes resins.

In another implementation, the resins are tackifying resins.

In another implementation, the aerosol adhesive further includes antioxidants.

In another implementation, the polymeric base is dissolved in the solvent mixture.

In another implementation, the polymeric base is suspended in the solvent mixture.

In another aspect, the invention features aerosol adhesive canister system, including a canister, a hose connected to the canister, a spray gun connected to the hose and an aerosol adhesive held within the canister, the aerosol adhesive including a thermoplastic polymeric base, a hexane and acetone solvent system, and a propellant gas dissolved in the solvent system.

In another aspect, the invention features an aerosol adhesive, including a thermoplastic polymer, a non-chlorinated solvent mixture and a propellant gas.

In one implementation, the non-chlorinated solvent mixture comprises hexane.

In another implementation, the non-chlorinated solvent mixture comprises acetone.

In another implementation, the propellant gas and the a thermoplastic polymer are dissolved in the solvent mixture.

In still another aspect, the invention features an aerosol adhesive blend, including a polymeric base blend dissolved in a solvent and a propellant gas dissolved in the solvent with the polymeric base.

In one implementation, the solvent is a hexane acetone blend.

In another implementation, the compressed gas is selected from the group consisting of carbon dioxide, nitrogen, nitrous oxide and air.

One advantage of the invention is that the volatile organic compounds level is lowered while maintaining a high quality aerosol adhesive blend.

Another advantage is that it provides a high solids adhesive solution propelled by compressed gases.

Another advantage is that the high solids adhesive solution includes characteristics that make the solution behave like a lower solids adhesive. Therefore, the same spray equipment can be used when applying this low VOC adhesive as when applying a high VOC adhesive. A user using a cannister containing the high solids adhesive solution who currently is spraying a high VOC adhesive, can simply change out the existing gun and hose from a high VOC canister and attach it to the low VOC cylinder or canister.

Another advantage is that the aerosol adhesive the solvent which solvent evaporates almost as quickly as the high toxicity chlorinated solvents such as methylene chloride. This advantage allows for the user to adhere the substrates quickly.

Another advantage in utilizing the high solids formulation is due to the fact there is less solvent in the adhesive film to evaporate prior to bonding.

Another advantage is that solvents are relatively non toxic.

Another advantage is that the compressed gases (CO₂, N2) used in the formulation are nonflammable.

A further advantage is that compressed gas used in the formulation can match up the spray pattern of a liquified gases. Typically, liquified gases dissolve in the concentrate. When sprayed out, the “pressure out” side of the aerosol can drop and the liquified gases goes from a liquid to a vapor. This transition helps break up the spray pattern to its desired effect.

Typically, the viscosity of the blend is approximately 1000 centipoise.

Another advantage is that the absorption rate of hexane acetone into CO₂ allows the mixture to work as a reliable non-flammable non-VOC propellant to move the rubber and resins in a manner that performs like a high solvent high VOC product without the inherent damage to the environment.

Another advantage is that once applied, the rate of evaporation of the formulation is greater than water based systems. This allows the applicator to assemble the adherents together faster using the formulation.

Other objects, advantages and capabilities of the invention will become apparent from the following description taken in conjunction with the accompanying drawings showing the preferred embodiment of the invention.

### DETAILED DESCRIPTION OF THE INVENTION

In general, embodiments are introduced that include an aerosol adhesive, including a polymeric base, a solvent mixture and a compressed gas that are adapted to be filled into a cannister including a hose connected to the canister and a spray gun connected to the hose.

In one embodiment, a large aerosol container of approximately 27 lb. contains high styrene block polymers and resins solutions in an acetone/hexane blend in a solvent blend. The overall percent of solids in the adhesive system is high. This system is refer to as a high solid systems. The more rubber and resin that is in the dissolved in the solvent (concentrate) the lower the percentage of solvent. This formulation therefore typically leads to the lower VOC content. Generally, in aerosol adhesives the solids of the concentrate is approximately 20 percent. It is usually difficult to increase the solids due to the fact that the viscosity of the concentrate increases exponentially with increasing polymer concentration. In this embodiment, the blend is solvent based and has unusually low VOC emissions due to its high solids in the concentrate. Additionally, in aerosol form, it has unusually low VOC emissions due to using compressed gas as the propellant.

The acetone/hexane blend typically evaporates quickly (almost as quickly as the methylene chloride) and the hexane/acetone and polymer selections allows for low viscosity solution. Typically, the solvent composition affects the polymer viscosity. Polymers are chosen that give the lowest viscosity in this solvent system. Typically, higher styrene block polymers give lower viscosity solutions that lower styrene block polymers. Typically, the viscosity of the blend is approximately 1000 centipoise.

By spraying out high viscosity blends using compressed gases yields lowered VOC emissions. By compressing a styrene adhesive with CO₂ produces a spray pattern that is very comparable with a low solid solution adhesive which utilizes using liquified gases such as propane and butane as a propellent to spray the adhesive out of an aerosol. This compressed gas implementation produces a fine, webbing spray pattern. CO₂ has the most favorable properties for being used as a compressed gas propellant because it is non-flammable, is readily soluble in many solvents, occurs naturally and is relatively inert. The solubility of the CO₂ in many solvents is important because of the fact that it helps in the pressure recover when the aerosol can is emptied, by the CO₂ coming back into gas form. Other gases can also be used in the formulation that have similar desirable properties as the CO₂. Such gases can include, but are not limited to, nitrous oxide, nitrogen and air.

In an embodiment, thermoplastic rubbers are used as the polymeric base. These rubbers are used to make contact and pressure sensitive adhesives. Contact adhesives are adhesives that are coated onto two or more different surfaces to be adhered together. Typically the surfaces are coated with the adhesive, then the two surfaces are pressed together. A common example of this is neoprene solvent counter top adhesive. The adhesive is applied to the laminate and to the particle board in which the laminate is to be mounted. The solvent is allowed to evaporate leaving behind the adhesive solids coated onto the laminate and the particle board. The two substrates are brought into contact with each other and bonding occurs. A pressure sensitive adhesive is an adhesive which is applied to one surface as a substrate and then this adhesive coated substrate is applied to a second surface. An example of this is a piece of tape. The tape contains the adhesive on a substrate which can then be applied to any surface with pressure.

Generally, to manufacture an aerosol adhesive, there are three basic polymer types used. They are styrene block polymers, styrene butadiene polymers and neoprene. Typically, styrene block polymers used in the manufacture of aerosol adhesives. As described above the aerosol adhesives are primarily solvent based. Solvent based aerosol adhesive consist primarily of propellants, a mixture of solvents and the polymeric material.

In addition to the polymeric base there are tackifying resins. These resins are long chain polymers which interact with the adhesive polymers. The tackifying resins may make the polymer sticky (as in pressure sensitive applications), give the polymer its contactability, or provide both properties. In addition, most aerosol adhesives contain some antioxidants which prevent the adhesive from oxidation.

Thermoplastic rubbers are used because they can be formulated with a wide degree of properties. Additionally, when compared to other polymer types thermoplastic rubbers give relatively low viscosity solutions. In aerosol formations, low viscosity solutions are much easier to spray out of an aerosol can than high viscosity solutions. The structure of thermoplastic rubbers are now described. On the ends of linear molecule is a block of polystyrene. This blocks are referred to as end blocks. The middle block is either polybutadiene, polyisoprene, polyethylene/butylene. The mid block is elastomeric and rubbery. The end block is hard and what gives the polymer its strength.

The unique structure of thermoplastic block copolymers offers possibilities to formulate with resins that associate with either the elastomeric mid-block or the polystyrene domains. This powerful formulating tool, supplemented by the use of plasticizer, fillers and antioxidants, allows the formulator to modify a wide range of adhesive performance properties such as tack, cohesive strength, holding power, stiffness and temperature resistance. In solvent based systems thermoplastic rubbers have the advantages of low viscosity, high solids contents and short dissolving times in a wide range of solvents.

The solubility of the propellent is important. As the aerosol can is emptied, the dissolve propellant boils from the concentrate to the head space of the aerosol is can. That is the propellant goes from being dissolve in the concentrate to the empty space on top of the concentrate. Typically, the more propellent which can be absorbed into the concentrate the less of a pressure drop that will occur when the can is emptied. For example, the hydrocarbon propellants liquify and mix with low solubility solvents, hydrocarbon solvents, and when the aerosol can is emptied, the propellent goes from a liquid to a vapor inside the can. Consequently, the pressure in the can is relatively constant.

The compressed gases such as nitrogen, nitrous oxide, and compressed air all seem to have low solubility in most solvents. However, the solubility of CO₂ in acetone is 12.08 percent by weight and the solubility of hexane is approximately 3.32 percent. The higher solubility of CO₂ than the other compressed gases leads to less of a pressure drop in an aerosol can when emptied.

### EXAMPLE 1

To a paddle blade mixer is added:

140 lb. of a solution of (50 percent hexane and 50 percent acetone)

42 lb. of Dexco 4411 (an SIS block polymer with 44 percent styrene)

28 lb. of Exxon Chemical 5637 (a resin which provides contactability of the isoprene mid block)

200 grams of Mayzo 10 (a phenolic antioxidant)

50 grams of Naugard P (a phosphite antioxidant)

The solution is mixed until the rubber and resin is dissolved. The adhesive mixture was pumped into a large aerosol container of approximately 22.13 Liters in size and then charged with CO₂. The container can be an Amtrol non-refillable cylinder fitted with a dip tube. The large aerosol container is shaken so that the solvent could absorb the CO₂ and more CO₂ is added to the container. The final pressure in the container is 120 psi. The container was fitted with Teleflex T1167-04 hose. The hose length is 6 foot. The hose is 1//4 inch in internal diameter. Additionally, the hose is constructed of steel braid and was thought to be Teflon lined. Attached to the hose was spray gun and inserted into the gun was a spraying tip. A GRACO flex airless spray gun is used. A Spraying Systems 9501 brass tip is used. The aerosol composition sprayed a fan pattern of approximately 6-8 inches. The spray pattern and properties of the adhesive when sprayed is similar to a high VOC aerosol formulation.

### EXAMPLE 2

The example is the same as in example 1 only that a 12 foot hose is used. The spray pattern is identical to the one using a 6 foot hose.

### EXAMPLE 3

The solution is prepared as in example 1 only that a 6.95 Liter cylinder from Amtrol was used. The pattern was exactly the same as spraying out of the larger cylinder.

### EXAMPLE 4

Same as example 1 only the canister was charged to 300 PSI. The canister sprayed out exactly the same.

### EXAMPLE 5

The solution solids solutions was increased to 40 percent and the same filling procedure was used as in example 1. The difference is that the solution sprayed out heavier than the current high VOC product. Producing a high solids low viscosity solution produces a product which matches up to the high VOC product.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. An aerosol adhesive, comprising:
a solvent mixture;
a polymeric base in the solvent mixture; and
a compressed gas dissolved in the solvent mixture.

2. The aerosol adhesive as claimed in claim 1, wherein the polymeric base includes styrene block polymers.

3. The aerosol adhesive as claimed in claim 1, wherein the polymeric base includes styrene butadiene polymers.

4. The aerosol adhesive as claimed in claim 1, wherein the polymeric base includes neoprene.

5. The aerosol adhesive as claimed in claim 1, wherein the solvent mixture comprises a blend of hexane and acetone.

6. The aerosol adhesive as claimed in claim 1, wherein the compressed gas is carbon dioxide.

7. The aerosol adhesive as claimed in claim 1, wherein the compressed gas is nitrous oxide.

8. The aerosol adhesive as claimed in claim 1, wherein the compressed gas is nitrogen.

9. The aerosol adhesive as claimed in claim 1, wherein the compressed gas is air.

10. The aerosol adhesive as claimed in claim 1 further comprising resins.

11. The aerosol adhesive as claimed in claim 10, wherein the resins are tackifying resins.

12. The aerosol adhesive as claimed in claim 1 further comprising antioxidants.

13. The aerosol adhesive as claimed in claim 1, wherein the polymeric base is dissolved in the solvent mixture.

14. The aerosol adhesive as claimed in claim 1, wherein the polymeric base is suspended in the solvent mixture.

15. An aerosol adhesive canister system, comprising:
a canister;
a hose connected to the canister;
a spray gun connected to the hose; and
an aerosol adhesive held within the canister, the aerosol adhesive comprising:
a thermoplastic polymeric base in a hexane and acetone solvent system; and
a propellant gas dissolved in the solvent system.

16. An aerosol adhesive, comprising:
a thermoplastic polymer;
a non-chlorinated solvent mixture; and
a propellant gas.

17. The aerosol adhesive as claimed in claim 16, wherein the non-chlorinated solvent mixture comprises hexane.

18. The aerosol adhesive as claimed in claim 16, wherein the non-chlorinated solvent mixture comprises acetone.

19. The aerosol adhesive as claimed in claim 16, wherein the propellant gas and the a thermoplastic polymer are dissolved in the solvent mixture.

20. An aerosol adhesive blend, comprising:
a polymeric base blend dissolved in a solvent; and
a propellant gas dissolved in the solvent with the polymeric base.

21. The aerosol adhesive blend as claimed in claim 20, wherein the solvent is a hexane acetone blend.

22. The aerosol adhesive blend as claimed in claim 20, wherein the compressed gas is selected from the group consisting of carbon dioxide, nitrogen, nitrous oxide and air.
